(19) United States
(12) Patent Application Publication
(10) Pub. No.: US 2016/0365548 A1
(43) Pub. Date: Dec. 15, 2016

(54) SODIUM CONDUCTING ENERGY STORAGE DEVICES COMPRISING COMPLIANT POLYMER SEALS AND METHODS FOR MAKING AND SEALING SAME

(71) Applicant: BATTELLE MEMORIAL INSTITUTE, Richland, WA (US)

(72) Inventors: Guosheng Li, Richland, WA (US); Hee-Jung Chang, Richland, WA (US); Vincent L. Sprenkle, Richland, WA (US)

(73) Assignee: BATTELLE MEMORIAL INSTITUTE, Richland, WA (US)

(21) Appl. No.: 15/226,570

(22) Filed: Aug. 2, 2016

Related U.S. Application Data
(63) Continuation-in-part of application No. 14/464,356, filed on Aug. 20, 2014.

(30) Foreign Application Priority Data
May 28, 2015 (US) PCT/US15/33012

(51) Int. Cl. H01M 2/08; H01M 10/054

(52) U.S. Cl. CPC H01M 2/08; H01M 10/054

(57) ABSTRACT

New compliant polymer seals and methods for making and sealing energy storage devices are disclosed. Compliant polymer seals become viscous at the operation temperature which seals cathode and anode chambers following assembly.

### CROSS REFERENCE TO RELATED APPLICATIONS

This application is a Continuation-In-Part of U.S. patent application Ser. No.: 14/464,356 filed 20 Aug. 2014, which is incorporated in its entirety herein.

### STATEMENT REGARDING RIGHTS TO INVENTION MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### FIELD OF THE INVENTION

The present invention relates generally to seals for sodium batteries. More particularly, the invention relates to a compliant polymer seal suitable for sodium energy storage devices and a process for making and sealing same.

### BACKGROUND OF THE INVENTION

Planar type ZEBRA (p-ZEBRA) batteries are far superior to tubular batteries in cell packaging, thermal control, mass production, and production simplicity. However, p-ZEBRA batteries have not yet been commercialized due to challenges associated with sealing large cells. Various sealing technologies have been proposed including seals made from glass, brazed metals, and metal alloys. However, none of these sealing materials has yet been implemented due to limitations in sealing temperatures, atmospheres, and thermal expansion compatibility in larger cells and batteries. And, while polymers of various types have been considered for sealing ZEBRA batteries, polymers have not been used to date due to high temperatures (e.g., 300° C.) needed for optimum operation of ZEBRA batteries that render conventional polymers unsuitable. Corrosion of polymers from secondary electrolytes such as NaAlCl₄ on the cathode side of the battery and from molten sodium on the anode side of the battery also remains a major challenge for use of polymer seals since corrosion decreases battery longevity and capacity during operation. Further, air leakage into the anode chamber due to poor seals can oxidize molten sodium and result in cell failure. Accordingly, new seals and methods are needed for sealing p-type ZEBRA batteries and other sodium-conducting batteries that function at lower temperatures, that resist corrosion, enhance longevity, and maintain performance over an extended period. The present invention addresses these needs.

### SUMMARY OF THE INVENTION

The present invention includes sodium ion-conducting energy storage devices. The energy storage device can include a first polymer seal positioned in at least one junction of a cathode chamber in contact with a primary solid state electrolyte that is inert to a secondary electrolyte comprising an alkali-metal aluminum halide therein. A second polymer seal can be positioned in at least one junction of an anode chamber in contact with the primary electrolyte that is inert to sodium metal therein. The seals can include a viscosity that seals the respective cathode and anode chambers and enhances the integrity or the strength of the polymer seals to prevent influx of oxidizing gases into the respective chambers at operation temperatures selected from about 100° C. to below about 300° C.

In some applications, the energy storage device can include a sodium-conducting solid state electrolyte as a primary electrolyte. The device may also include a first polymer seal comprises of a polymer selected from polytetrafluoroethylene (PTFE); fluorinated ethylene propylene (FEP); perfluoroalkoxy alkanes (PFA); or polyethylene (PE) positioned in at least one junction of a cathode chamber in contact with the primary electrolyte on the cathode side of the storage device that is inert to a secondary electrolyte comprising a sodium-metal or potassium metal aluminum halide therein. The device may also include a metal mesh positioned in the anode chamber adjacent the solid electrolyte that is configured to maintain contact between sodium metal and the solid electrolyte therein. The device may also include a second polymer seal comprising a polymer selected from polyvinylidene fluoride (PVDF); or polyethylene (PE) positioned in at least one junction of an anode chamber in contact with the primary electrolyte on the anode side of the storage device that is inert to sodium metal formed therein. The polymer seals have a viscosity selected to seal the respective cathode and anode chambers and prevent influx of external oxidizing gases therein at operation temperature selected above about 100° C. to below about 300° C.

In some applications, the first polymer seal includes a polymer different from the polymer in the second polymer seal.

In some applications, the first polymer seal includes a polymer that is identical to the polymer in the second polymer seal.

In some applications, the first polymer seal or the second polymer seal comprises ultra-high molecular weight polyethylene.

In some applications, the first polymer seal comprises polytetrafluoroethylene (PTFE); fluorinated ethylene propylene (FEP); perfluoroalkoxy alkanes (PFA); or polyethylene (PE).

In some applications, the second polymer seal comprises polyvinylidene fluoride (PVDF), or polyethylene (PE).

In some applications, the first and second polymer seals are not laminated.

In some applications, first and second polymer seals are composite polymer seals that include a viscosity modifier of up to about 50% by weight therein.

In some applications, first and second polymer seals are composite polymer seals that include a viscosity modifier that is encapsulated by the first or second polymer therein.

In some applications, the first polymer seal comprises polytetrafluoroethylene (PTFE); fluorinated ethylene propylene (FEP); perfluoroalkoxy alkanes (PFA); or polyethylene (PE); and the second polymer seal comprises polyvinylidene fluoride (PVDF).

In some applications, the first polymer seal comprises polytetrafluoroethylene (PTFE) and the second polymer seal comprises polyvinylidene fluoride (PVDF).

In some applications, the first polymer seal comprises polytetrafluoroethylene (PTFE) and the second polymer seal comprises polyethylene (PE).

In some applications, the first polymer seal comprises fluorinated ethylene propylene (FEP) and the second polymer seal comprises polyvinylidene fluoride (PVDF).

In some applications, the first polymer seal comprises fluorinated ethylene propylene (FEP) and the second polymer seal comprises polyethylene (PE).

In some applications, the first polymer seal comprises perfluoroalkoxy alkane (PFA) and the second polymer seal comprises polyvinylidene fluoride (PVDF).

In some applications, the first polymer seal comprises perfluoroalkoxy alkane (PFA) and the second polymer seal comprises polyethylene (PE).

In some applications, the energy-storage device includes a metal mesh positioned in the anode chamber in contact with the solid state electrolyte that maintains contact between sodium metal and the solid electrolyte therein.

In some applications, the energy-storage device includes an anode shim positioned in the anode chamber adjacent the solid state electrolyte that accumulates sodium metal therein and enhances conductivity.

The present invention includes new polymer seals comprises polymers that are inert to secondary electrolytes such as alkali-metal aluminum halides including sodium and potassium aluminum halides.

In some applications, the compliant seals include a polyethylene polymer positioned at junctions on the anode side of the battery cell.

In some applications, compliant polymer seals may be coated with coating materials including, but not limited to, for example, epoxy-based coatings, ceramic-based coatings, silicone-based coatings, and combinations of these materials to prevent or minimize oxidation of the polymer seals.

In some applications, compliant polymer seals may be positioned between a structural support that defines the cathode and anode chambers and the cell casing that encloses the cathode and anode chambers to seal the respective chambers.

In some applications, the compliant polymer seal may be positioned between a cathode chamber and an anode chamber on respective sides of a sodium-conducting beta-alumina solid electrolyte.

In various applications, compliant polymer seals may be positioned, e.g., at the entrance to or exit from the anode and cathode chambers, between the solid state electrolyte and the cell casing that encloses the cathode and anode chambers, and/or channels that proceed to or lead from the cathode and anode chambers. No limitations are intended.

In some applications, compliant polymer seals may be positioned between the solid state electrolyte and the cathode chamber to seal the cathode chamber that contains the cathode electrolyte (NaAlClₓBr_{y}, where x+y=4) during operation.

In some applications, compliant polymer seals may be positioned between the solid state electrolyte and the anode chamber to seal the anode chamber that contains molten sodium metal during operation.

The present invention also includes a method for sealing sodium-conducting energy storage devices. The method can include the following steps. A first compliant seal comprises a polymer selected from polytetrafluoroethylene (PTFE); fluorinated ethylene propylene (FEP); perfluoroalkoxy alkane (PFA); or polyethylene (PE) can be introduced in at least one junction of a cathode chamber in contact with a primary electrolyte on the cathode side of the storage device that is inert to a secondary electrolyte comprising an alkali-metal aluminum halide therein. A second compliant seal comprises a polymer different from the first polymer selected from polyvinylidene fluoride (PVDF); or polyethylene (PE) that can be introduced in at least one junction of an anode chamber in contact with the primary electrolyte on the anode side of the storage device that is inert to sodium metal formed therein. The first and second polymer seals seal the respective cathode and anode chambers and prevent influx of the external oxidizing gases therein at selected operation temperatures.

In some applications, compliant seals seal the energy storage device at an operation temperature from about 100° C. to about 300° C.

In some applications, energy storage devices that include the compliant seals exhibit a performance degradation of less than about 5% on average over at least 200 charge-discharge cycles at a discharge current of 10 mA/cm² at selected operation temperatures compared with energy storage devices that do not include the compliant seals.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows an exemplary ZEBRA battery sealed with compliant polymer seals, according to one embodiment of the present invention.

FIG. 2 shows exemplary polymers used in concert with compliant polymer seals of the present invention.

FIGS. 3A-3C show structures of compliant polymer seals composed of composites of selected polymers and viscosity modifiers, according to different embodiments of the present invention.

FIGS. 4A-4B show different views of another ZEBRA battery sealed with compliant polymer seals, according to another embodiment of the present invention.

FIG. 5 shows an exemplary large ZEBRA cell sealed with compliant polymer seals, according to another embodiment of the present invention.

FIG. 6 plots capacity for the battery of FIG. 1 as a function of cycle number.

FIG. 7 plots energy efficiency for the battery of FIG. 1 as a function of cycle number.

FIG. 8A plots voltage for the battery of FIG. 1 as a function of state-of-charge.

FIG. 8B plots voltages at the end-of-charge (EOC) and the end-of-discharge (EOD) for the battery of FIG. 1.

FIG. 9 plots voltage and energy efficiency for the large battery of FIG. 5 as a function of cycle number.

### DETAILED DESCRIPTION OF PREFERRED EMBODIMENTS

The present invention includes new compliant seals that include selected polymers, polymer composites, and modifiers selected for sealing sodium-conducting energy storage devices, for example, ZEBRA batteries. A method for sealing these devices with compliant polymer seals is also detailed that allows operation at selected temperatures. In the following description, embodiments of the present invention are shown and described by way of illustration of the best mode contemplated for carrying out the invention. It will be clear that the invention is susceptible of various modifications and alternative constructions. It should be understood that there is no intention to limit the invention to the specific forms disclosed, but, on the contrary, the invention is intended to cover all modifications, alternative constructions, and equivalents falling within the spirit and scope of the invention as defined in the claims. Therefore the description should be seen as illustrative and not limiting.

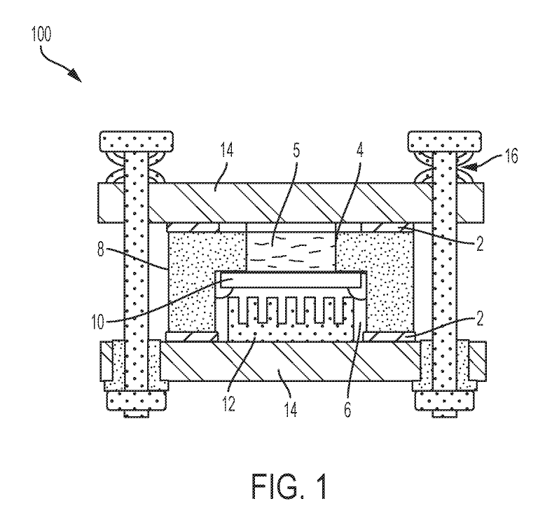

FIG. 1 shows an exemplary ZEBRA energy storage device 100 sealed with compliant polymer seals 2 of the present invention. Storage device 100 may include a cathode chamber 4 with a cathode 5 and an anode chamber 6 with an anode 7. In the instant embodiment, cathode chamber 4 and anode chamber 6 may be machined into a structural support 8 constructed of selected ceramics such as α-alumina, refractory ceramics such as zirconia, or other structural materials. No limitations are intended. In the instant embodiment, a solid state solid electrolyte 10 such as, for example, a β″-alumina solid electrolyte (BASE) is shown installed between cathode chamber 4 and anode chamber 6. BASE 10 delivers sodium ions (Na⁺) between cathode 5 and anode 7 positioned in anode chamber 6 during operation. Anode chamber 6 may include an anode shim 12 that accumulates sodium metal formed at the surface of BASE 10 in anode chamber 6 to enhance conductivity during operation. In the figure, cathode chamber 4 and anode chamber 6 are enclosed in a cell casing 14 positioned on opposite sides of the storage device. Cell casing 14 may be constructed of various non-limiting materials including, for example, metals and metal alloys such as Hastelloy®, and ceramics. In the instant embodiment, cell casing 14 is held in place on respective sides of the storage device with a compression spring 16 or other compression device that ensures a tight seal. Viscosity of the compliant polymer seals can be increased to accommodate the compression load as detailed herein. In the figure, compliant polymer seals 2 are shown positioned at a junction 18 between support 8 and cell casing 14 that seals cathode chamber 4 on the cathode side of storage device 100 and at a junction 18 between support 8 and cell casing 14 that seals anode chamber 6 on the anode side of storage device 100. Seals may also be used to provide electrical separation between the cell chambers. Location of the seals is not limited. In some embodiments, secondary sealing materials 20 may also be used to prevent infusion of oxidative gases into the cathode and anode chambers that can degrade the seals and the performance of the storage device. Secondary materials include, but are not limited to, for example, plastics; epoxies; glasses; ceramics; insulating ceramics; metals; silicones; electrical isolation materials; and combinations of these materials.

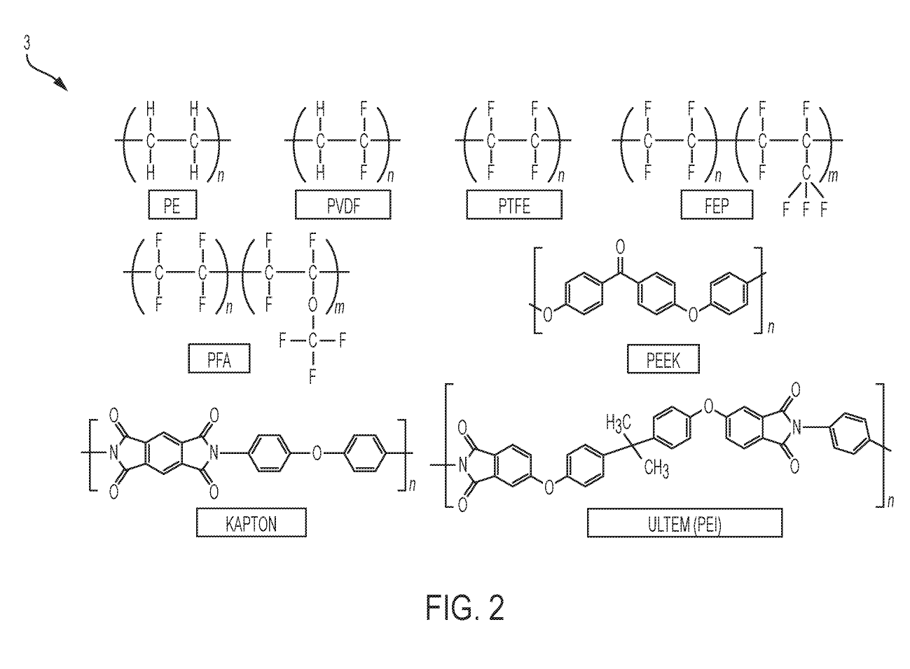

FIG. 2 shows exemplary polymers 3 used in the compliant polymer seals 2. Polymers suitable for use have a decomposition temperature above the operating temperature of the storage device. Polymers selected for the cathode side of the storage device can include, but are not limited to, polyvinylidene fluorides (PVDF); or ultra-high molecular weight (UHMW) polyethylenes (PE). Polymers selected for the anode side of the storage device can include, but are not limited to, polytetrafluoroethylenes (PTFE); fluorinated ethylene propylenes (FEP), perfluoroalkoxy alkanes (PFA), or UHMW polyethylenes (PE). Polymer seals are configured to become viscous at operation temperatures to seal junctions in the energy storage device. Viscosities are not limited and may be tailored by selection of the polymer, the molecular weight of the polymer, and by addition of modifiers.

In one embodiment, the polymer seal is comprised of UHMW polyethylene with a molecular weight selected between about 3.5 million Daltons (Da) and about 7.5 million (Da). Higher molecular weights are preferable for higher temperature operation; lower molecular weights are preferable for lower temperature operation.

In some embodiments, compliant polymer seals may also be coated with secondary materials described previously to improve sealing properties or to accommodate thermal expansion mismatches between components in the cell during operation.

### EXAMPLE 1

Various polymers were tested for compatibility in contact with a cathode material, NaAlCl₄, and with sodium metal used in the anode at 200° C. TABLE 1 lists polymers and results for the listed polymer seals.

TABLE 1

| | Cathode | Anode |
|---|---|---|
| | Electrolyte | Sodium Metal |
| Polymer | [NaAlCl₄] | [Na] |
| PTFE | Good | Fail |
| PVDF | Fail | Good |
| FEP | Good | Fail |
| PFA | Good | Fail |
| PEI | Fail | Fail |
| PEEK | Fail | Fail |
| PI | Fail | Fail |
| PE | Good | Good |

PTFE(polytetrafluoroethylene); PVDF(polyvinylidene fluoride); FEP(fluorinated ethylene propylene); PFA (Perfluoroalkoxy alkanes); PEI (polyetherimide) such as ULTEM ®; PEEK(polyether ether ketone); PI (polyimides) such as KAPTON ®; and UHMW PE(Polyethylene).

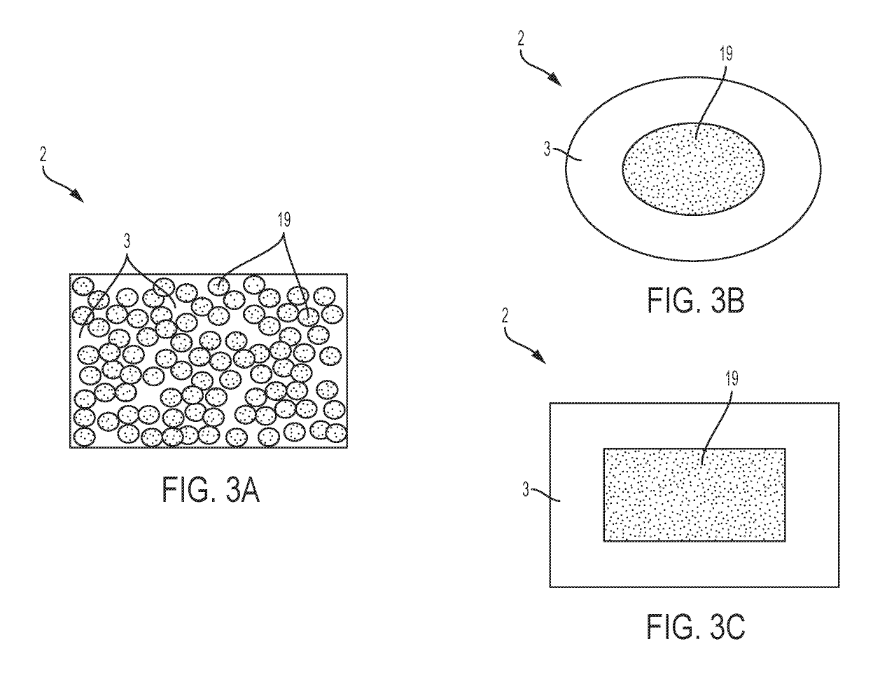

In some embodiments, viscosity, integrity, or mechanical strength of the polymer seal can be enhanced by addition of a modifier to the polymer or by encapsulating the modifier with the polymer. Modifiers suitable for use are compatible with the cathode, cathode electrolytes, and the anode. Preferred modifiers include, but are not limited to, for example, glasses; epoxies; plastics; ceramics such as alumina or zirconia; and electrical isolation materials. FIG. 3A illustrates a compliant polymer seal 2 composed of a mixed composite that includes the selected polymer 3 and the viscosity modifier 19. In some embodiments, fine powders of the polymer and the modifier are mixed in a selected solvent to form a homogenous mixture and the solvent is then evaporated to form the composite seal. Composite polymer seals can include a weight fraction of the modifier up to about 50% by weight. FIG. 3B and FIG. 3C show structures of different composite seals 2. In these embodiments, seal 2 includes a modifier 19 that is surrounded with the polymer 3. In some embodiments, the modifier is encapsulated by hot pressing the polymer over the modifier to form the seal. Composite seals can then be cut or machined into selected shapes. No limitations are intended.

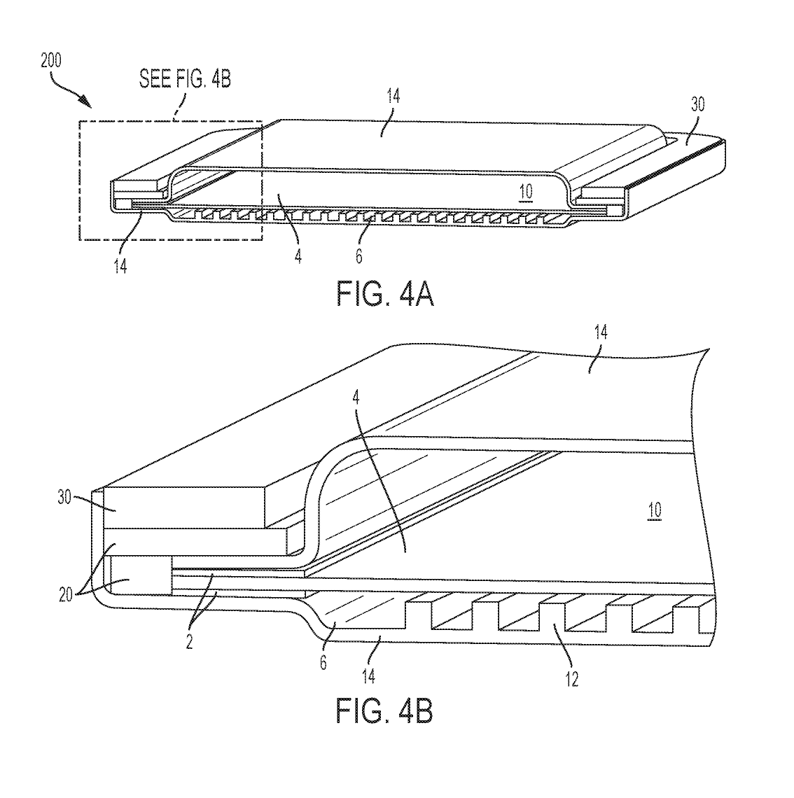

FIGS. 4A-4B show different views of another ZEBRA storage device 200 of a planar cell design configured with compliant polymer seals 2 and other components described previously in reference to FIG. 1. In the instant embodiment, a retaining ring 30 secures the casing 14 on the cathode side of the storage device and on the anode side of the storage device. In the figure, compliant polymer seals 2 are positioned, for example, between cell casing 14 and solid electrolyte 10 on the cathode side of the storage device and between cell casing 14 and the solid electrolyte 10 on the anode side of the device and at other selected locations. For example, seals may also be positioned, e.g., at respective ends of BASE 10 below retaining ring 30 to seal cathode chamber 4 and anode chamber 6 to isolate the cathode from the anode, and to prevent release of secondary electrolyte from the cathode chamber that can degrade performance of the storage device.

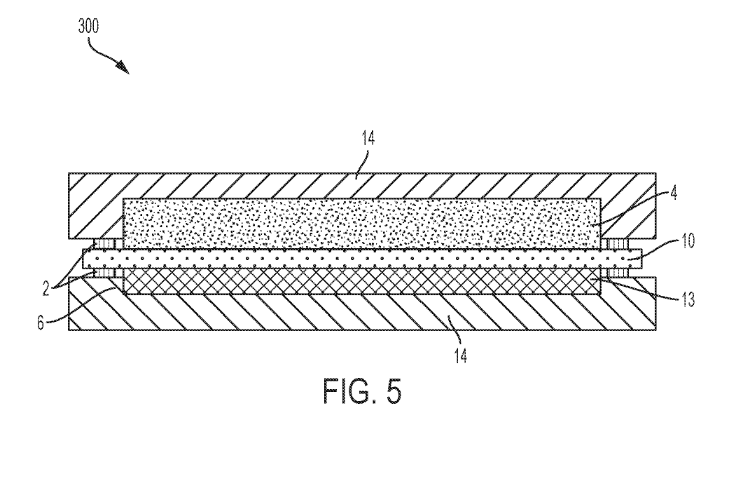

FIG. 5 shows another embodiment of a ZEBRA storage device 300 configured with compliant polymer seals 2 and other components described previously in reference to FIG. 1. In the instant embodiment, a metal mesh 13 such as a steel mesh is positioned inside anode chamber 6 in contact with solid state electrolyte 10 that enhances contact between sodium metal and the surface of the solid electrolyte that improves and wetting of the surface. In the instant embodiment, the metal mesh has a thickness of about 500 micrometers, but thickness is not intended to be limited. In the cathode chamber 4, Ni—NaCl granules are loaded which are infiltrated by the secondary electrolyte (NaAlCl₄). In operation, the ZEBRA storage device gave a typical capacity and energy of are about 1.8 Ah and 5 Wh, respectively.

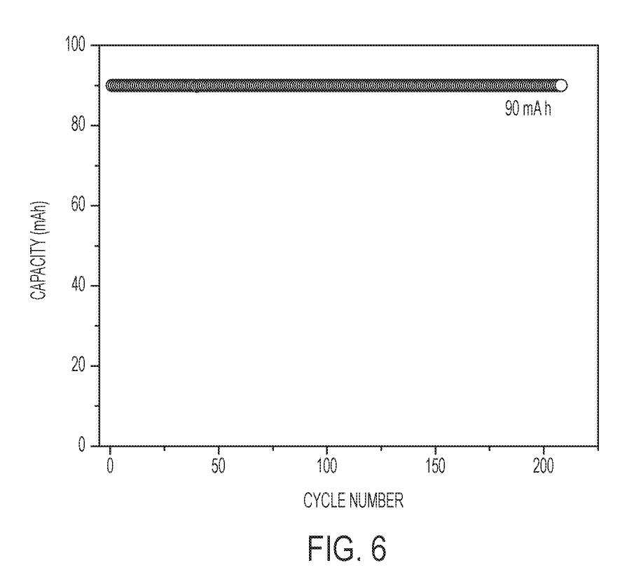

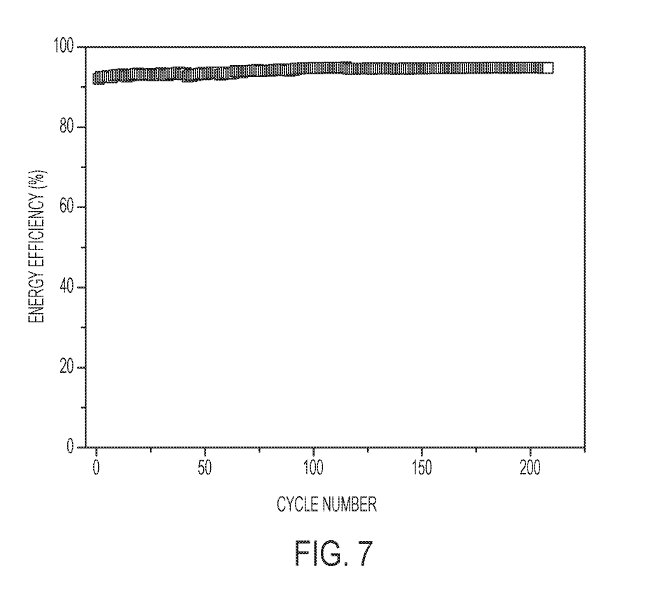

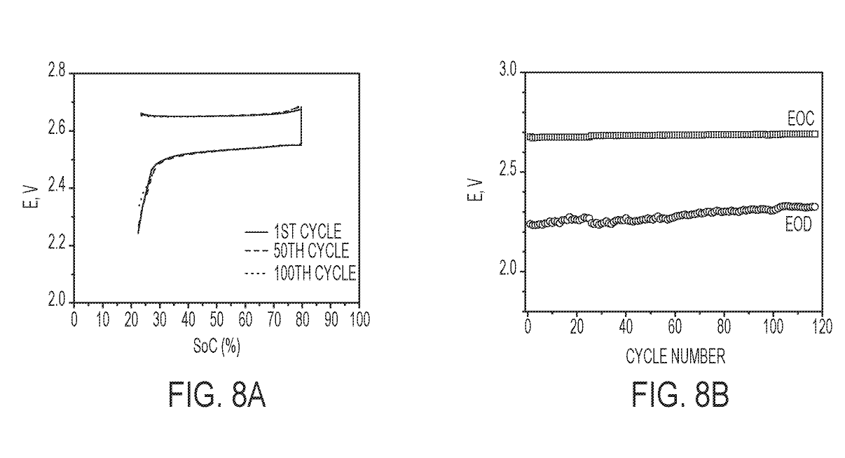

FIG. 6 plots capacity in milliamp hours (mAh) for the ZEBRA cell of FIG. 1 as a function of cycle number. Capacity remains steady over a cycle lifetime of at least 200 charge-discharge cycles at a power discharge current of 10 milliamps per square centimeter (mA/cm²) at the selected operation temperature. FIG. 7 plots energy efficiency (%) of the ZEBRA battery as a function of cycle number. Energy efficiency decreases less than about 5% over the same cycle lifetime. FIG. 8A plots cell potential of the ZEBRA battery in volts as a function of SoC. FIG. 8B plots voltage at the end of charge (EOC) and the end of discharge (EOD) of the ZEBRA battery in volts as a function of cycle number. Integrity of the cell potential remains intact as evidenced by an absence of hysteresis over the same cycle lifetime. Results are attributed to properties provided by the compliant polymer seals including their sealing capacity, longevity, and resistance to corrosion.

### EXAMPLE 2

A planar cell was prepared in a nitrogen-purged glove box (O₂ and H₂O<0.1 ppm). consisting of stainless steel end-caps as a cell casing, an α-alumina (99.5% purity) structural support, and polymer-O rings. A custom-made β″-alumina/yttria-stabilized zirconia (YSZ) composite solid-state electrolyte (BASE) disc was glass-sealed to the α-alumina support. The anode side of the BASE surface was heat-treated at 400° C. to improve sodium wetting after applying aqueous lead acetate (Pb(CH₃COO)₂) solution. Cathode granules comprised of Ni—NaCl (1.0 g, 157 mAh, 52.3 mAh cm⁻²) and 0.8 g of NaAlCl₄ secondary electrolyte were loaded into the cathode chamber on the cathode side of the support at an elevated temperature of 200° C. and then vacuum infiltrated. A small amount of sodium metal (Aldrich 99.9%) was added to the anode shim at room temperature to facilitate an initial contact of molten sodium therein. Polymer O-rings were placed on the top (cathode) and the bottom (anode) of the support as a primary seal. PE and PVDF polymers were used to seal the anode chamber. Other fluorinated polymers (PTFE, FEP, PFA, etc.) and PE were used to seal the cathode chamber. The cell was initially cycled between the cutoff voltages of 2.8 V (charge limit) and 1.8 V (discharge limit) at 10 mA at a temperature of 190° C. in order to maximize cell charge capacity. After the initial charge/discharge cycle, fixed-capacity cycling tests were conducted at a charge current of 20 mA (7 mA/cm²) and a discharge current of 30 mA (10 mA/cm²) at a state of charge (SoC) window between 20% and 80% (e.g., 90 mAh, 60% of theoretical capacity).

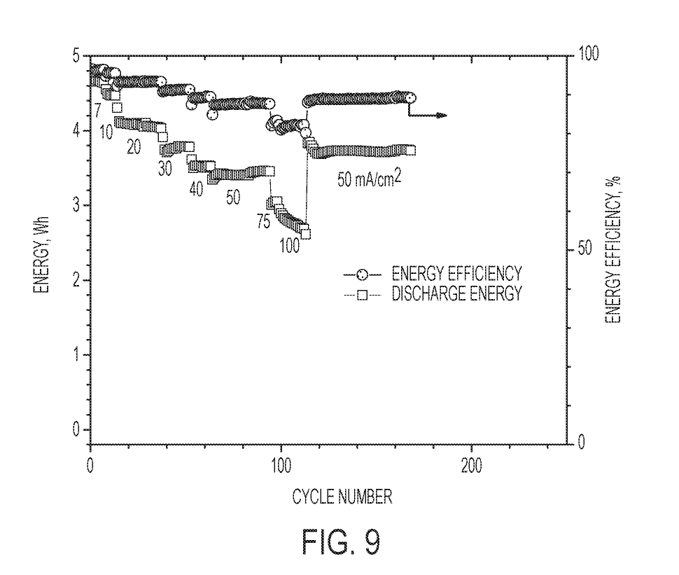

FIG. 9 plots specific energy (Wh) and energy efficiency (%) for the large battery of FIG. 5 operated at different discharge current densities as a function of cycle number. The battery utilizes 4.8 Wh of energy out of a theoretical energy density of 5 Wh when operated at a charge current density of 7 mA/cm² (˜C/7), thus operating at an energy efficiency as high as 96%. As shown in the figure, the battery shows a stable capacity trend at a discharge current up to 75 mA/cm² (1.5 C). Capacity only begins to decay if the battery is operated at a discharge current density of 100 mA/cm² (or 2 C). In the long term, no degradation in capacity is observed when cycling at 50 mA/cm² (1 C). When cycled at this capacity, energy efficiency of the battery is about 89%. Results show battery performance is stable when the battery is assembled with compliant seals described herein.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the present invention.

What is claimed is:

1. An energy-storage device, comprising:
a first polymer seal disposed in at least one junction of a cathode chamber in contact with a primary solid state electrolyte that is inert to a secondary electrolyte therein comprising an alkali-metal aluminum halide; and
a second polymer seal disposed in at least one junction of an anode chamber in contact with the primary electrolyte that is inert to sodium metal therein;
whereby the seals include a viscosity that seal the respective cathode and anode chambers at operation temperatures from about 100° C. to about 300° C.

2. The energy-storage device of claim 1, wherein the first polymer seal comprises a polymer different from the polymer in the second polymer seal.

3. The energy-storage device of claim 1, wherein the first polymer seal or the second polymer seal is comprised of ultra-high molecular weight polyethylene.

4. The energy-storage device of claim 1, wherein the first polymer seal comprises a polymer selected from: polytetrafluoroethylene (PTFE); fluorinated ethylene propylene (FEP); perfluoroalkoxy alkanes (PFA); or polyethylene (PE).

5. The energy-storage device of claim 1, wherein the second polymer seal comprises a polymer selected from polyvinylidene fluoride (PVDF), or polyethylene (PE).

6. The energy-storage device of claim 1, wherein the first and second polymer seals are composite seals comprising a viscosity modifier of up to about 50% by weight therein.

7. The energy-storage device of claim 1, wherein the first and second polymer seals are composite seals comprising a viscosity modifier that is encapsulated by the first or second polymer therein.

8. The energy-storage device of claim 1, wherein the first polymer seal comprises a polymer selected from: polytetrafluoroethylene (PTFE); fluorinated ethylene propylene (FEP); perfluoroalkoxy alkanes (PFA); or polyethylene (PE); and the second polymer seal comprises polyvinylidene fluoride (PVDF).

9. The energy-storage device of claim 1, wherein the first polymer seal comprises polytetrafluoroethylene (PTFE) and the second polymer seal comprises polyvinylidene fluoride (PVDF).

10. The energy-storage device of claim 1, wherein the first polymer seal comprises polytetrafluoroethylene (PTFE) and the second polymer seal comprises polyethylene (PE).

11. The energy-storage device of claim 1, wherein the first polymer seal comprises fluorinated ethylene propylene (FEP) and the second polymer seal comprises polyvinylidene fluoride (PVDF).

12. The energy-storage device of claim 1, wherein the first polymer seal comprises fluorinated ethylene propylene (FEP) and the second polymer seal comprises polyethylene (PE).

13. The energy-storage device of claim 1, wherein the first polymer seal comprises perfluoroalkoxy alkane (PFA) and the second polymer seal comprises polyvinylidene fluoride (PVDF).

14. The energy-storage device of claim 1, wherein the first polymer seal comprises perfluoroalkoxy alkane (PFA) and the second polymer seal comprises polyethylene (PE).

15. The energy-storage device of claim 1, further including a metal mesh disposed in the anode chamber in contact with the solid electrolyte therein.

16. The energy-storage device of claim 1, further including an anode shim disposed in the anode chamber adjacent the solid electrolyte therein.

17. A sodium-conducting energy-storage device, comprising:
a sodium ion-conducting solid state electrolyte as a primary electrolyte;
a first polymer seal comprising a first polymer selected from polytetrafluoroethylene (PTFE); fluorinated ethylene propylene (FEP); perfluoroalkoxy alkanes (PFA); or polyethylene (PE) disposed in at least one junction of a cathode chamber in contact with the primary electrolyte on the cathode side of the storage device that is inert to a secondary electrolyte comprising a sodium-metal or potassium metal aluminum halide therein; and
a metal mesh disposed in the anode chamber in contact with the solid electrolyte configured to maintain contact between sodium metal and the solid electrolyte therein; and
a second polymer seal comprising a polymer selected from polyvinylidene fluoride (PVDF); or polyethylene (PE) disposed in at least one junction of an anode chamber in contact with the primary electrolyte on the anode side of the storage device that is inert to sodium metal formed therein;
whereby the first and second seals have a selected viscosity that seal the respective cathode and anode chambers and prevent influx of external oxidizing gases therein at operation temperatures above about 100° C. to below about 300° C.

18. A method for sealing a sodium-conducting energy storage device, comprising the steps of:
introducing a first compliant seal comprising a first polymer selected from polytetrafluoroethylene (PTFE); fluorinated ethylene propylene (FEP); a perfluoroalkoxy alkane (PFA); or polyethylene (PE) disposed in at least one junction of a cathode chamber in contact with a primary electrolyte on the cathode side of the storage device that seals the cathode chamber and is inert to a secondary electrolyte comprising an alkali-metal aluminum halide introduced therein;
introducing a second compliant seal comprising a second polymer different from the first polymer selected from polyvinylidene fluoride (PVDF); or polyethylene (PE) disposed in at least one junction of an anode chamber in contact with the primary electrolyte on the anode side of the storage device that seals the anode chamber and components therein preventing influx of the external oxidizing gas therein and is inert to sodium metal formed therein;
whereby the first and second seals include a viscosity that seal the respective cathode and anode chambers at a selected operation temperature.

19. The method of claim 18, wherein the operation temperature is selected from about 100° C. to about 300° C.

20. The method of claim 18, wherein the seals in operation provide a performance degradation in the energy storage device of less than about 5% over at least 200 charge-discharge cycles at a discharge current of 10 mA/cm².
